(19) United States
(12) Patent Application Publication
(10) Pub. No.: US 2014/0204781 A1
(43) Pub. Date: Jul. 24, 2014

(54) METHOD AND DEVICE FOR DETERMINING A SIGNAL DETECTION QUALITY FOR A PHYSICAL CONTROL CHANNEL

(71) Applicants: Michael Horvat, Muenchen (DE); Bertram Gunzelmann, Koenigsbrunn (DE)

(72) Inventors: Michael Horvat, Muenchen (DE); Bertram Gunzelmann, Koenigsbrunn (DE)

(21) Appl. No.: 14/138,218

(22) Filed: Dec. 23, 2013

Related U.S. Application Data
(60) Provisional application No. 61/754,686, filed on Jan. 21, 2013.

(51) Int. Cl. H04W 24/08; H04W 72/04

(52) U.S. Cl. CPC H04W 24/08; H04W 72/042
USPC 370/252

(57) ABSTRACT

A method for determining a signal detection quality for a physical control channel is provided. The method may include detecting, via a physical control channel, a first group of at least one radio resource element and a second group of at least one radio resource element, wherein the first group and the second group are non-contiguous in time and frequency with respect to radio resource elements of the physical control channel; and determining the signal detection quality based on the detected first group of resource elements and the detected second group of resource elements.

### CROSS-REFERENCE TO RELATED APPLICATION

This application claims the benefit of U.S. Provisional Application No. 61/754,686, filed on Jan. 21, 2013.

### TECHNICAL FIELD

Various aspects of this disclosure relate to a method and a device for determining a signal detection quality for a physical control channel.

### BACKGROUND

In a mobile communication standard, such as Long Term Evolution (LTE) Release 11, enhanced physical downlink control channel (EPDCCH) [3GPP TS 36.211] has been recently introduced to increase the channel capacity compared to the legacy physical downlink control channel (PDCCH). The capacity enhancement is required by the co-operative multi-point (CoMP) scenarios, which allocate multiple pieces of User Equipment (UEs) at the same time-frequency resource element (RE).

EPDCCH can handle such CoMP scenarios with multiple UEs, e.g. not delaying or skipping the scheduling of CoMP UEs. Since either PDCCH or EPDCCH is used [3GPP TS 36.213], an EPDCCH operating UE, e.g. in CoMP transmission modes (TM) 9 or 10, cannot apply the radio link monitoring (RLM) feature In-/Out-of-Sync, which is based on the joint PDCCH— Physical Control Format Indicator Channel (PCFICH) Block Error Ratio (BLER) of the actual link. Another RLM feature for such Sync-Loss detection [3GPP TS 36.133] should be established, which is then based on EPDCCH. The relation between Sync-Loss detection and PDCCH is the avoidance of unscheduled Uplink (UL) transmission of the UE by wrongly decoded PDCCH UL grants. It is important for the network performance that UEs monitor the joint BLER of EPDCCH and PDCCH detection quality. The Out-of-Sync state is reached, if the joint, PDCCH and PCFICH, BLER exceeds 10%. The UE is allowed to enter the In-Sync state, if the PDCCH-PCFICH BLER falls below 2% [3GPP TS 36.133]. Therefore, a similar mechanism has to be introduced for EPDCCH transmission, which contains the UE-specific control search space (USS) in Release 11 (see agreement below). For Release 12, transport of both, common search space (CSS) and USS, over EPDCCH is under discussion.

In the following description PDCCH BLER will be referred to as joint PDCCH/PCFICH BLER.

Once EPDCCH is transmitted and decoding by UE is required, the legacy RLM sync loss detection for PDCCH needs to be extended to EPDCCH as well. Otherwise, PDCCH might be decoded with sufficient SINR margin, whereas EPDCCH might not.

Conventionally the UE monitors both legacy PDCCH UE search space (USS) and common search space (CSS) in subframes, which are not assigned to EPDCCH USS.

As of today, no solution is specified to cover EPDCCH-based SyncLoss detection.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosure. In the following description, various embodiments of the disclosure are described with reference to the following drawings, in which:

FIG. 1 shows a Legacy PDCCH Sync Loss State Diagram;

FIG. 2 shows generic Out-of-Sync and In-Sync characteristics;

FIG. 3 shows a resource element allocation for PDCCH and EPDCCH in an LTE-specific time-frequency grid;

FIG. 4 shows a flow diagram which illustrates various relations between EPDCCH-only or joint EPDCCH-PDCCH/PCFICH processing that feature SyncLoss detection in EPDCCH network scenarios;

FIG. 5 shows a flow diagram which illustrates the joint-BLER metric as it relates to either the EPDCCH-only or joint EPDCCH-PDCCH/PCFICH processing that feature SyncLoss detection in EPDCCH network scenarios;

FIG. 6 shows a flow diagram in accordance with various aspects of this disclosure, which illustrates a method for detecting a first group of radio resource element(s) and a second group of radio resource element(s), where the first group and the second group are non-contiguous in time and frequency with respect to radio resource elements of the physical control channel and determining the signal detection quality based on the detected first group of resource elements and the detected second group of resource elements;

FIG. 7 shows a flow diagram in accordance with various aspects of this disclosure which illustrates the method of FIG. 6, where the determined signal detection quality may be used to control a communication device;

FIG. 8 shows a flow diagram in accordance with various aspects of this disclosure which illustrates a method for determining a signal detection quality for a first physical control channel and a second physical control channel; FIG. 9 shows a flow diagram in accordance with various aspects of this disclosure which illustrates a further method for controlling a communication device;

FIG. 10 shows an exemplary device determining a signal detection quality for a physical control channel in accordance with various aspects of this disclosure;

FIG. 11 shows an exemplary device controlling a communication device in accordance with various aspects of this disclosure;

FIG. 12 shows another exemplary device determining a signal detection quality for a first physical control channel and a second physical control channel in accordance with various aspects of this disclosure;

FIG. 13 shows another exemplary device controlling a communication device in accordance with various aspects of this disclosure; and

FIG. 14 shows a mobile radio communication system in accordance with various aspects of this disclosure.

### DESCRIPTION

The following detailed description refers to the accompanying drawings that show, by way of illustration, specific details and embodiments in which the disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

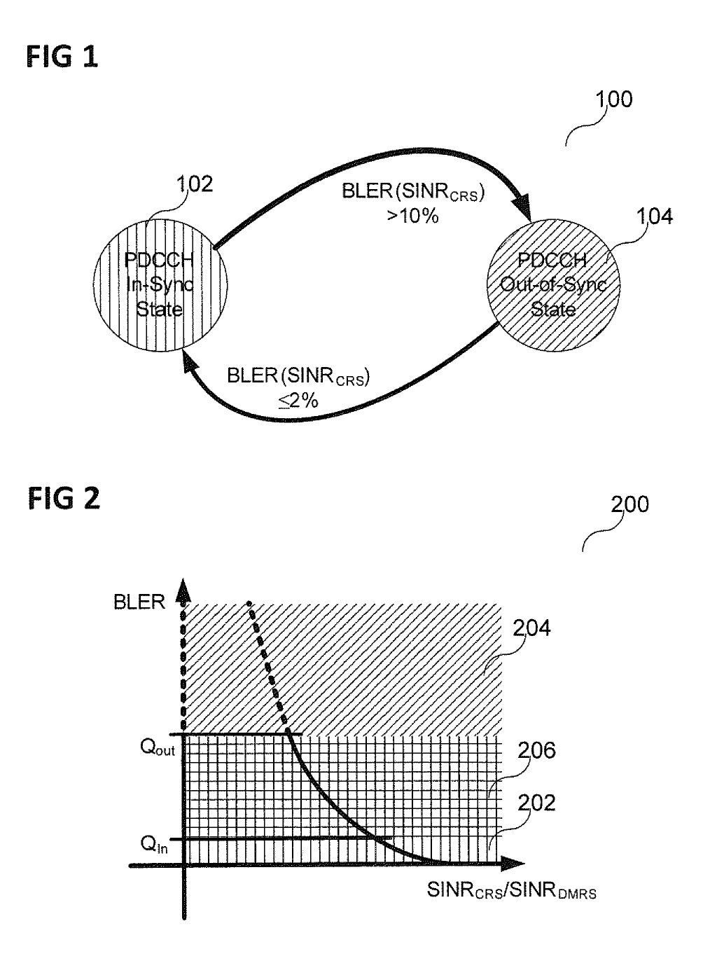

The legacy PDCCH-based SyncLoss detection feature follows the procedure illustrated in a state diagram 100 of a communication device (e.g. a UE) in FIG. 1. FIG. 2 shows the generic relation between joint physical downlink control channel (PDCCH) and Physical Control Format Indicator Channel Block Error Ratio (PCFICH BLER), the CRS (Cell specific reference signals) based SINR (signal-to-interference plus noise-ratio), which the UE estimates, and the thresholds that trigger the two sync states, namely a first sync state 102 (also referred to as In-Sync state 102) and a second sync state 104 (also referred to as Out-of-Sync state 104) in a diagram 200. A first region 202 marks an In-Sync region 202, in which the communication device (e.g. the UE) is in the In-Sync state 102, a second region 204 marks an Out-of-Sync region 204, in which the communication device is in the Out-of-Sync state 104 and a third region 206 illustrates an undefined area 206, which results in a Hysteresis that prevents limit cycles between both states 102, 104.

As for the disadvantages of the state-of-the-art PDCCH sync loss detection, the CRS used to derive the pass/fail criterion are not precoded. The EPDCCH, however, is based on UE-specific demodulation reference signals (DMRS), which are both precoded.

The precoding changes the channel characteristic. CRS-based SINR and DMRS-based SINR provide different results. E.g. channel estimation for PDCCH relies on CRS, which cannot be used for channel estimation of precoded signals, such as the physical downlink shared channel (PDSCH) and enhanced physical downlink control channel (EPDCCH). DMRS are transmitted over the same precoded channel matrix as the EPDCCH.

Various aspects of this disclosure provide a solution for the conventionally missing SyncLoss detection in PDCCH subframes, where the communication device (e.g. the UE) only monitors EPDCCH. E.g. the case, where EPDCCH USS is not detected correctly.

A SyncLoss detection feature for RLM may be provided, which is based on EPDCCH detection quality to ensure network-consistent and non-catastrophic UE UL (User Equipment Uplink) scheduling, e.g. induced by wrong EPDCCH USS decoding. Those UEs, which do not meet minimum EPDCCH performance requirements, may not be scheduled to avoid destructive interference with correctly scheduled UEs in the same network. Without various aspect of this disclosure and without legacy PDCCH, the UE is not able to technically support the legacy radio link monitoring (RLM) In-/Out-of-Sync feature and respective metrics [as described in 3GPP TS 36.133].

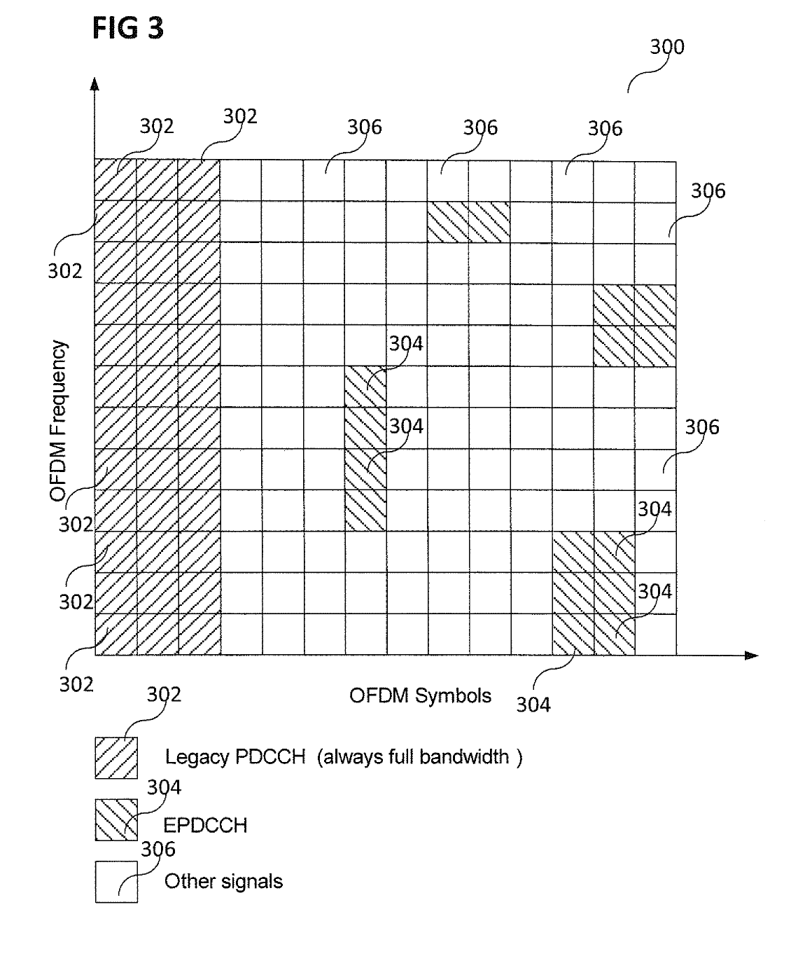

FIG. 3 shows a resource element allocation for PDCCH and EPDCCH in an LTE-specific time-frequency grid diagram 300.

As shown in FIG. 3, the resource element allocation may include
allocating legacy PDCCH resource elements 302 (always with full bandwidth);
allocating EPDCCH resource elements 304; and/or
allocating resource elements 306 provided for other signals.

Various aspects of this disclosure allow EPDCCH-only or joint EPDCCH-PDCCH/PCFICH processing that features SyncLoss detection in EPDCCH network scenarios:

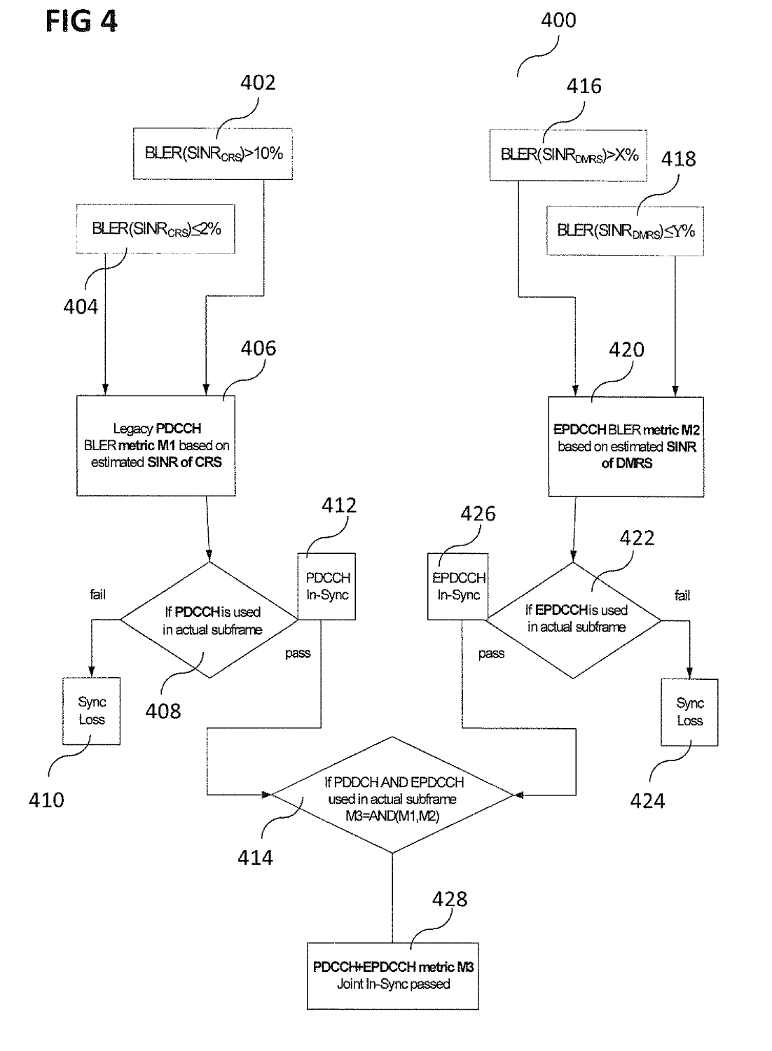

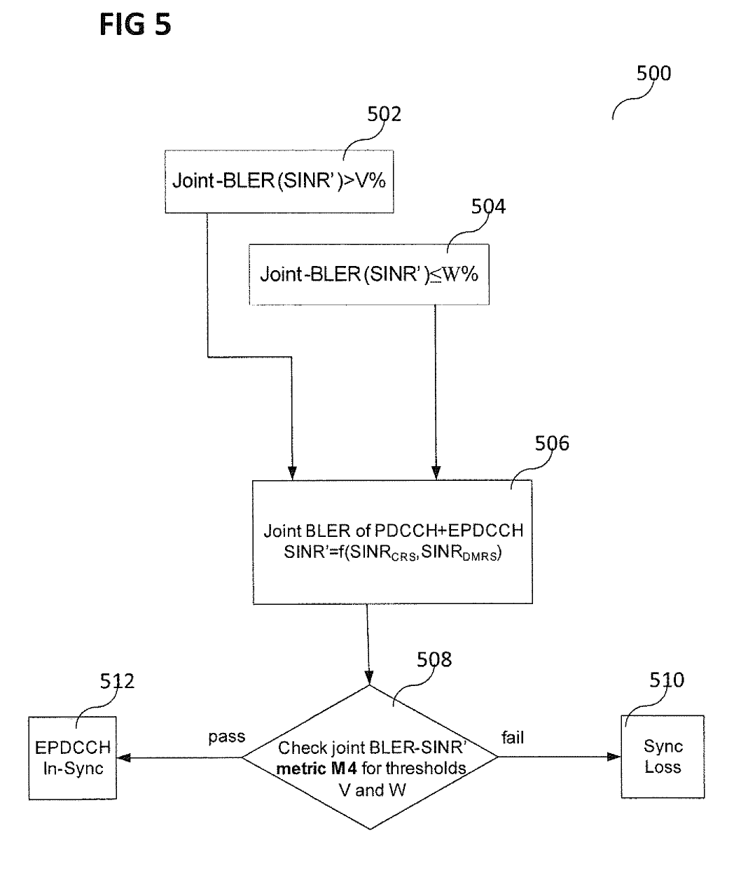

Item 1 (as Will be Described in More Detail Below with Reference to FIG. 4):

If the UE would only receive EPDCCH in the actual subframe, configured via radio resource control (RRC), then only the novel EPDCCH metric M2 in accordance with various aspects of this disclosure may be checked.

If both, PDCCH and EPDCCH, are jointly transmitted in a subframe, the UE may first apply a predefined metric M2 to the EPDCCH. Then, the UE may process the legacy PDCCH metric M1 with the EPDCCH metric M2 to result in a predefined combined metric M3. This metric M3 finally may decide on the sync loss state.

If EPDCCH is not transmitted at all, e.g. the UE may only transmit the PDCCH, and may apply the legacy metric M1.

Item 2 (as Will be Described in More Detail Below with Reference to FIG. 5):

If both, PDCCH and EPDCCH, present in a subframe, determine transformed SINR′=f(SINRCRS, SINRDMRS), at which the joint BLER of EPDCCH+PDCCH reaches In-Sync or Out-of-Sync threshold.

If only EPDCCH in a subframe, then apply predefined metric M2.

If only PDCCH in a subframe, then apply legacy metric M1.

The UE may use EPDCCH detection quality (BLER) based on DMRS SINR to derive a metric M2 that decides whether the UE is In-Sync (Y %) or Out-of-Sync (X %) state. Also the joint PDCCH-EPDCCH quality metric M3 is proposed to maintain the legacy PDCCH-based SyncLoss metric M1 as minimum requirement.

The UE may derive the predefined metric M2 for EPDCCH-only transmission in a similar manner as the legacy PDCCH M1 metric, but based on DMRS resulting in different thresholds X and Y for the precoded channel conditions. The metric M3 basically checks whether both sub-metrics M1 and M2 are passed, e.g. by doing a XOR-operation. This 3-process approach provides seamless backwards compatibility to legacy PDCCH-only application.

All metric may follow the basic principle as illustrated in FIG. 2, e.g. a priori.

As shown in FIG. 4, a controller of the communication device (e.g. the UE) after having determined a signal to noise ratio of the cell-specific reference signal (SINR_{CRS}) for a detected PDCCH in a subframe, determines as to whether the block error ratio of the signal to noise ratio of the cell-specific reference signal (BLER(SINR_{CRS})) is larger than 10% (Block 402). Next, the controller determines as to whether the BLER(SINR_{CRS}) is equal to or smaller than 2% (Block 404). In 406, the controller evaluates a legacy PDCCH BLER metric M1 based on estimated SNIR of CRS. Then, in 408, the controller determines as to whether PDCCH is used in actual (current) subframe. If this is not the case (fail in 408), the communication device enters into the RRC PDCCH state SyncLoss (Out-of-Sync state 104 in FIG. 1), as shown in Block 410. If the controller determines that PDCCH is used in actual (current) subframe (pass in 408), the controller continues the process in 412, wherein the communication device enters into the RRC PDCCH state PDCCH In-Sync (In-Sync state 102 in FIG. 1). Then, the controller continues the process in 414, which will be described in more detail below.

As also shown in FIG. 4, after the controller has determined a signal to noise ratio of the demodulation reference signal (SINR_{DMRS}) for a detected EPDCCH in a subframe, the controller determines as to whether the block error ratio of the signal to noise ratio of the demodulation reference signal is larger than X % (X is a freely selectable value) (Block 416). Furthermore, the controller subsequently determines as to whether the BLER(SINR_{DMRS}) is equal to or smaller than Y % (Y is a freely selectable value smaller than X) (Block 418). In 420, the controller evaluates an EPDCCH BLER metric M2 based on estimated SNIR of DMRS. Then, in 422, the controller determines as to whether EPDCCH is used in actual (current) subframe. If this is not the case (fail in 422), the communication device enters into the RRC EPDCCH state SyncLoss (Out-of-Sync state 104 in FIG. 1), as shown in Block 424. If the controller determines that EPDCCH is used in actual (current) subframe (pass in 422), the controller continues the process in 426, wherein the communication device enters into the RRC EPDCCH state EPDCCH In-Sync (In-Sync state 102 in FIG. 1). Then, the controller continues the process in 414.

In 414, the controller determines if PDDCH AND EPDCCH are both used in actual (current) subframe based on a predefined third metric M3, which may be a logic AND function of M1 and M2 (M3=AND (M1, M2)). In case the third metric M3 fulfills a predefined criterion, e.g. M3=1, the controller determines that PDCCH and EPDCCH metric M3 joint In-Sync is passed (Block 428).

As an alternative approach, the controller may calculate the combined BLER of PDCCH+EPDCCH and may apply it as a single metric on this joint stream BLER. However, this approach would mix up the different channel metrics of PDCCH/PCFICH and precoded EPDCCH as well as the SINR estimates based on CRS and DMRS respectively. Therefore, a transformed SINR′, which is determined by a function of the CRS-based SINR_{CRS} and the DMRS-based SINR_{DMRS}, indicates the a priori thresholds (V % and W %) for the In-Sync and Out-of-Sync states.

For a more detailed processing flow see the flow diagram 500 in FIG. 5.

FIG. 5 illustrates the joint-BLER metric M4 and the scenarios described above.

As shown in FIG. 5, after the controller has determined a transformed SINR′_{DMRS} for a detected EPDCCH in a subframe, the controller determines as to whether a Joint-BLER(SINR′_{DMRS}) is larger than V % (V is a freely selectable value) (Block 502). Furthermore, the controller subsequently determines as to whether the transformed Joint-BLER(SINR′_{DMRS}) is equal to or smaller than W % (W is a freely selectable value smaller than V) (Block 504). In 506, the controller determines a Joint-BLER of PDCCH+EPDCCH in accordance with:

SINR′=f(SINR_{CRS}, SINR_{DMRS}) where SINR′ is defined as a function of the signal to noise ratio of the demodulation reference signal (SINR_{DMRS}) and the signal to noise ratio of the cell-specific reference signal (SINR_{CRS}).

Then, in 508, the controller checks the Joint-BLER-SINR′ metric M4 for the thresholds V and W. If 508 fails, the communication device enters into the RRC EPDCCH state SyncLoss (Out-of-Sync state 104 in FIG. 1) (the state as such is described in ETSI TS 136 331 V11.1.0, chapter 5.3.11.3), as shown in Block 510. If 508 is passed, the controller determines that EPDCCH is used in actual (current) subframe (pass in 508), the controller continues the process in 512, wherein the communication device enters into the RRC EPDCCH state EPDCCH In-Sync (In-Sync state 102 in FIG. 1).

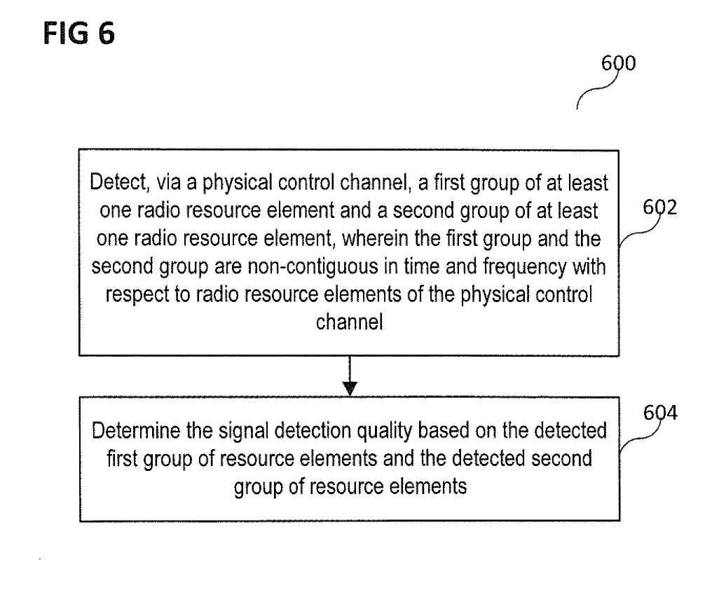

FIG. 6 shows a flow diagram 600 of a method for determining a signal detection quality for a physical control channel in accordance with various aspects of this disclosure. The process begins in 602, detecting, via a physical control channel, a first group of at least one radio resource element and a second group of at least one radio resource element, wherein the first group and the second group are non-contiguous in time and frequency with respect to radio resource elements of the physical control channel. Next, in 604, the method includes determining the signal detection quality based on the detected first group of resource elements and the detected second group of resource elements.

The physical control channel may be a physical downlink control channel. Furthermore, the physical downlink control channel may be an enhanced physical downlink control channel. Moreover, the physical downlink control channel may control an uplink transmission scheduling of a communication device. The physical downlink control channel may control a communication device specific uplink transmission scheduling of the communication device. The detecting the first group of at least one radio resource element and the second group of at least one radio resource element may include determining a signal to noise ratio of the detected resource element of the first group of at least one radio resource element and a signal to noise ratio of the detected resource element of the second group of at least one radio resource element. Moreover, the detecting the first group of at least one radio resource element and the second group of at least one radio resource element may include determining a signal to interference plus noise ratio of the detected resource element of the first group of at least one radio resource element and a signal to interference plus noise ratio of the detected resource element of the second group of at least one radio resource element. The signal to noise ratio of the detected resource elements may be determined based on precoded reference signals. The signal to noise ratio of the detected resource elements may be determined taking beam forming into account.

Furthermore, a method for determining a signal detection quality for a physical control channel may include, determining a signal detection quality for an enhanced physical downlink control channel (EPDCCH), which may include: detecting, via the EPDCCH, a plurality of radio resource elements; and determining the signal detection quality based on the detected plurality of radio resource elements.

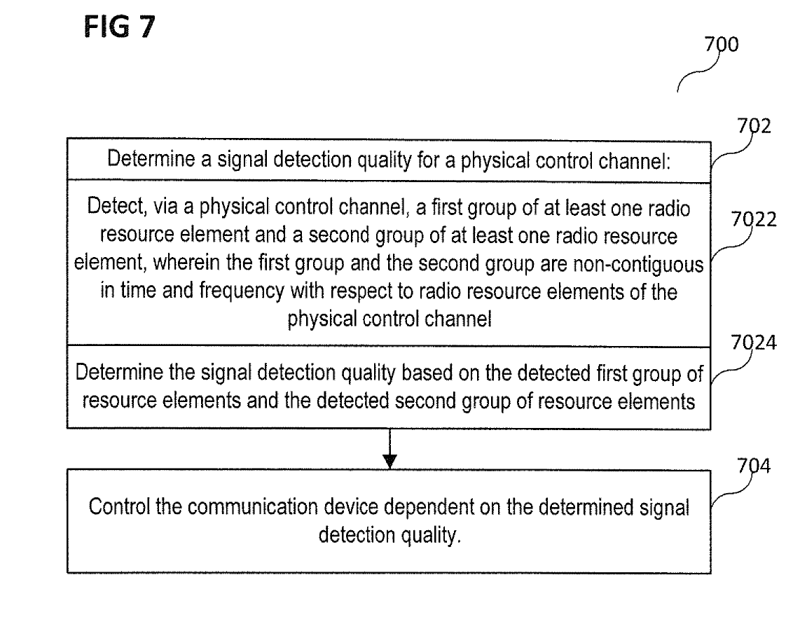

FIG. 7 shows a flow diagram 700 of a method for controlling a communication device in accordance with various aspects of this disclosure.

The process begins in 702 by determining a signal detection quality for a physical control channel, which may include: detecting, in 7022, via a physical control channel, a first group of at least one radio resource element and a second group of at least one radio resource element, wherein the first group and the second group are non-contiguous in time and frequency with respect to radio resource elements of the physical control channel. Next, in 7024, it includes determining the signal detection quality based on the detected first group of resource elements and the detected second group of resource elements. Next, in 706, the method may further include controlling the communication device dependent on the determined signal detection quality.

The controlling the communication device may include controlling the communication device into a synchronization state dependent on the determined signal detection quality. The synchronization state may be a Radio Resource Control (RRC) synchronization state. A controller may control the communication device to enter into an In-Synchronization state if the determined signal detection quality is higher than a predefined quality threshold. Furthermore, the controller may control the communication device to enter into an Out-of-Synchronization state if the determined signal detection quality is equal to or smaller than a predefined quality threshold. The physical control channel may be a physical downlink control channel. The physical downlink control channel may be an enhanced physical downlink control channel. The physical downlink control channel may control an uplink transmission scheduling of a communication device. Furthermore, the physical downlink control channel may control a communication device specific uplink transmission scheduling of the communication device. The detecting the first group of at least one radio resource element and the second group of at least one radio resource element may include determining a signal to noise ratio of the detected resource element of the first group of at least one radio resource element and a signal to noise ratio of the detected resource element of the second group of at least one radio resource element. The detecting the first group of at least one radio resource element and the second group of at least one radio resource element may include determining a signal to interference plus noise ratio of the detected resource element of the first group of at least one radio resource element and a signal to interference plus noise ratio of the detected resource element of the second group of at least one radio resource element. The controller may determine the signal to noise ratio of the detected resource elements based on precoded reference signals. The controller may determine the signal to noise ratio of the detected resource elements based on demodulation reference signals. Furthermore, the controller may determine the signal to noise ratio of the detected resource elements taking beam forming into account.

Furthermore, a method for controlling a communication device may include, determining a signal detection quality for an enhanced physical downlink control channel (EPDCCH), which may include: detecting, via the EPDCCH, a plurality of radio resource elements; and determining the signal detection quality based on the detected plurality of radio resource elements. The method may further include controlling the communication device dependent on the determined signal detection quality.

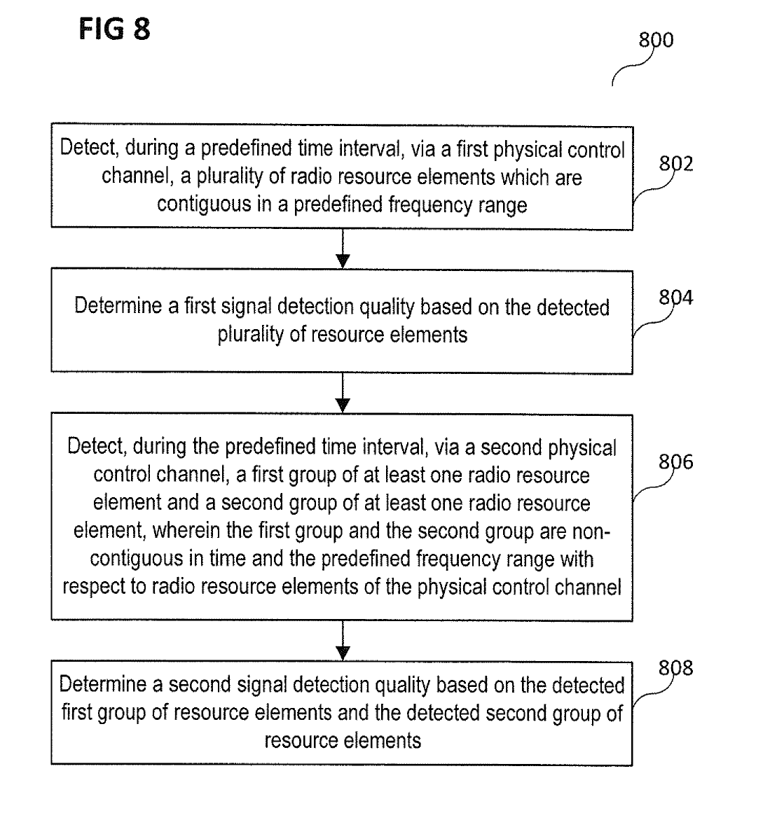

FIG. 8 shows a flow diagram 800 of a method for determining a signal detection quality for a first physical control channel and a second physical control channel in accordance with various aspects of this disclosure.

The process begins in 802, detecting, during a predefined time interval, via a first physical control channel, a plurality of radio resource elements which are contiguous in a predefined frequency range. Next, in 804, determining a first signal detection quality based on the detected plurality of resource elements. Furthermore, the method may include, in 806, detecting, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel, and, in 808, determining a second signal detection quality based on the detected first group of resource elements and the detected second group of resource elements.

The first physical control channel may be a physical downlink control channel; and the second physical control channel may be an enhanced physical downlink control channel. The second physical downlink control channel may control an uplink transmission scheduling of a communication device. The second physical downlink control channel may control a communication device specific uplink transmission scheduling of the communication device. The first physical downlink control channel may control a transmission scheduling common for a plurality of communication devices. The detecting the first group of at least one radio resource element and the second group of at least one radio resource element may include determining a signal to noise ratio of the detected resource element of the first group of at least one radio resource element and a signal to noise ratio of the detected resource element of the second group of at least one radio resource element. Furthermore, the detecting the first group of at least one radio resource element and the second group of at least one radio resource element may include determining a signal to interference plus noise ratio of the detected resource element of the first group of at least one radio resource element and a signal to interference plus noise ratio of the detected resource element of the second group of at least one radio resource element. The signal to noise ratio of the detected resource elements may be determined based on precoded reference signals. The signal to noise ratio of the detected resource elements may be determined based on demodulation reference signals. The signal to noise ratio of the detected resource elements may be determined taking beam forming into account. Detecting the plurality of radio resource elements which are contiguous in the predefined frequency range may include determining a signal to noise ratio of the detected resource elements. Detecting the plurality of radio resource elements which are contiguous in the predefined frequency range may include determining a signal to interference plus noise ratio of the detected resource elements. Furthermore, a controller may determine the signal to noise ratio of the detected resource elements based on non-precoded reference signals. Furthermore, a controller may determine the signal to noise ratio of the detected resource elements based on radio cell specific reference signals. Moreover, the predefined time interval may be a predefined time frame. The predefined time interval may be a predefined time subframe.

FIG. 9 shows a flow diagram 900 of another method for controlling a communication device in accordance with various aspects of this disclosure.

The process begins in 902, by determining a signal detection quality for a first physical control channel and a second physical control channel, which in turn may include detecting, during a predefined time interval, via a first physical control channel, a plurality of radio resource elements which are contiguous in a predefined frequency range, determining a first signal detection quality based on the detected plurality of resource elements.

Next, the method may include, in 904, detecting, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel; and determining a second signal detection quality based on the detected first group of resource elements and the detected second group of resource elements.

Next, the method may include, in 906, controlling the communication device dependent on the determined signal detection qualities.

The controlling the communication device may include controlling the communication device into a synchronization state dependent on the determined signal detection qualities. Furthermore, the synchronization state may be a Radio Resource Control (RRC) synchronization state. The communication device may be controlled to enter into an In-synchronization state if the determined signal detection quality of the first physical control channel is higher than a first predefined quality threshold, and if the determined signal detection quality of the second physical control channel is higher than a second predefined quality threshold. Moreover, the communication device may be controlled to enter into an Out-of-Synchronization state if at least one of the determined signal detection quality of the first physical control channel is equal to or smaller than a first predefined quality threshold, and the determined signal detection quality of the second physical control channel is equal to or smaller than a second predefined quality threshold. The communication device may be controlled to enter into an In-Synchronization state if a predefined function taking into account the determined signal detection quality of the first physical control channel and the determined signal detection quality of the second physical control channel fulfills a predefined quality criterion.

FIG. 14 shows a mobile radio communication system 1400. A radio communication device 1402 may receive a signal from a first base station 1404, for example wirelessly like indicated by arrow 1408. The radio communication device 1402 may further receive a signal from a second base station 1406, for example wirelessly like indicated by arrow 1410. The radio communication device 1402 may perform measurements of the second radio base station 1406 while a communication connection with the first radio base station 1404 is established. The radio communication device 1402 may include or be one of the communication devices as described above or as will be described in the following.

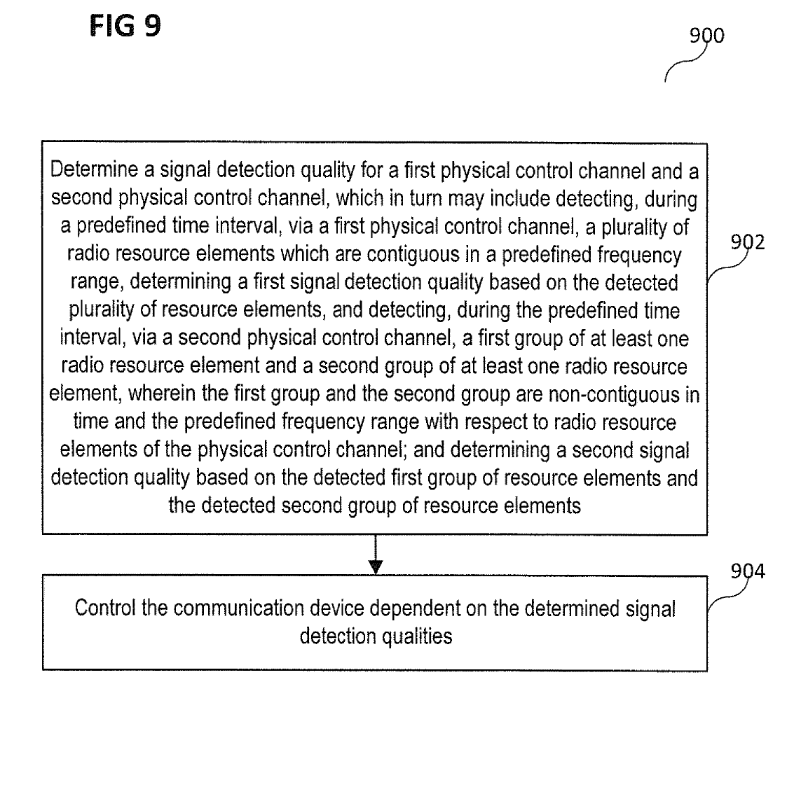

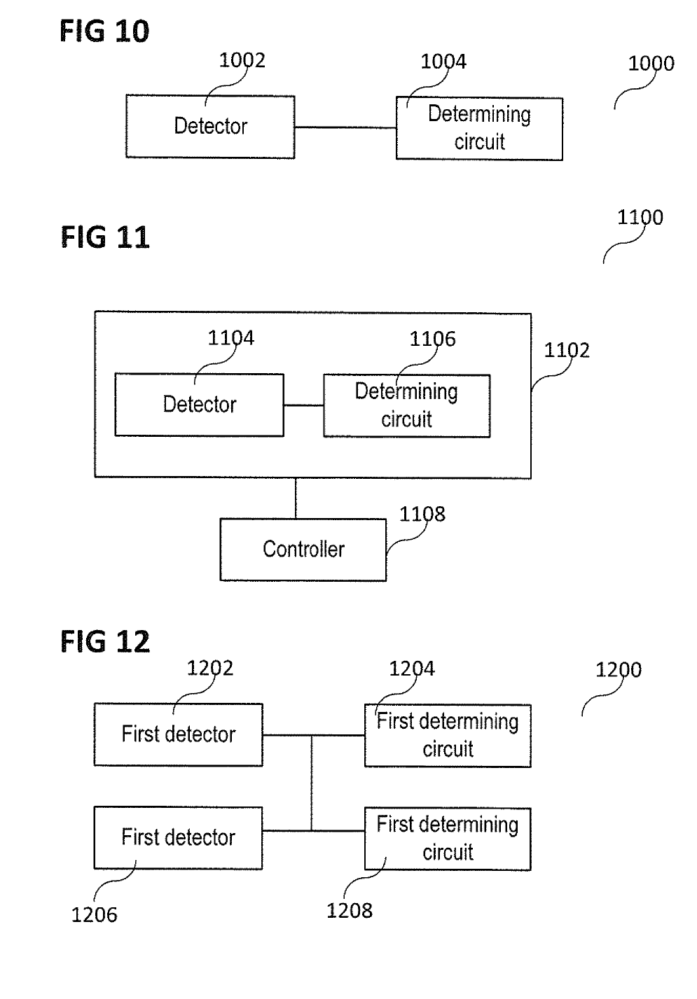

FIG. 10 shows an exemplary device 1000 for determining a signal detection quality for a physical control channel in accordance with various aspects of this disclosure. The device 1000 may be an implementation of the radio communication device 1402 as shown in FIG. 14. The device 1000 may include a detector 1002 configured to detect, via a physical control channel, a first group of at least one radio resource element and a second group of at least one radio resource element, wherein the first group and the second group are non-contiguous in time and frequency with respect to radio resource elements of the physical control channel; and a determining circuit 1004 (which may be coupled to the detector) configured to determine the signal detection quality based on the detected first group of resource elements and the detected second group of resource elements.

The physical control channel may be a physical downlink control channel. The physical downlink control channel may be an enhanced physical downlink control channel. Furthermore, the physical downlink control channel may control an uplink transmission scheduling of a communication device. The physical downlink control channel may control a communication device specific uplink transmission scheduling of the communication device. By way of example, the detector 1002 may further be configured to determine a signal to noise ratio of the detected resource element of the first group of at least one radio resource element and a signal to noise ratio of the detected resource element of the second group of at least one radio resource element. The detector 1002 may further be configured to determine a signal to interference plus noise ratio of the detected resource element of the first group of at least one radio resource element and a signal to interference plus noise ratio of the detected resource element of the second group of at least one radio resource element. The detector 1002 may further be configured to determine the signal to noise ratio of the detected resource elements based on precoded reference signals. Furthermore, the detector 1002 may further be configured to determine the signal to noise ratio of the detected resource elements taking beam forming into account.

A device for determining a signal detection quality for a physical control channel in accordance with various aspects of this disclosure may include a detector configured to detect, via an enhanced physical downlink control channel (EPDCCH), a plurality of radio resource elements; and a determining circuit (which may be coupled to the detector) configured to determine the signal detection quality based on the detected plurality of resource elements.

FIG. 11 shows another exemplary device 1100 for controlling a communication device in accordance with various aspects of this disclosure. The device 1100 may be an implementation of the radio communication device 1402 as shown in FIG. 14. The device 1100 may include a circuit 1102 configured to determine a signal detection quality for a physical control channel, wherein the circuit 1102 may include: a detector 1104 configured to detect, via a physical control channel, a first group of at least one radio resource element and a second group of at least one radio resource element, wherein the first group and the second group are non-contiguous in time and frequency with respect to radio resource elements of the physical control channel; and a determining circuit 1106 configured to determine the signal detection quality based on the detected first group of resource elements and the detected second group of resource elements. The device 1100 may further include a controller 1108 (which may be coupled to the circuit 1102) configured to control the communication device dependent on the determined signal detection quality.

The controller 1108 may be configured to control the communication device into a synchronization state depending on the determined signal detection quality. Furthermore, the synchronization state may be a Radio Resource Control (RRC) synchronization state. The controller 1108 may further be configured to control the communication device to enter into an In-Synchronization state if the determined signal detection quality is higher than a predefined quality threshold. The controller 1108 may be configured to control the communication device to enter into an Out-of-Synchronization state if the determined signal detection quality is equal to or smaller than a predefined quality threshold. Moreover, the physical control channel may be a physical downlink control channel. The physical downlink control channel may be an enhanced physical downlink control channel. The physical downlink control channel may control an uplink transmission scheduling of a communication device. The physical downlink control channel may control a communication device specific uplink transmission scheduling of the communication device. The detector 1104 may be configured to determine a signal to noise ratio of the detected resource element of the first group of at least one radio resource element and a signal to noise ratio of the detected resource element of the second group of at least one radio resource element. The detector 1104 may be configured to determine a signal to interference plus noise ratio of the detected resource element of the first group of at least one radio resource element and a signal to interference plus noise ratio of the detected resource element of the second group of at least one radio resource element. The detector 1104 may be configured to determine the signal to noise ratio of the detected resource elements based on precoded reference signals. Moreover, the detector 1104 may be configured to determine the signal to noise ratio of the detected resource elements based on demodulation reference signals. The detector may be configured to determine the signal to noise ratio of the detected resource elements taking beam forming into account.

FIG. 12 shows yet another exemplary device 1200 for determining a signal detection quality for a first physical control channel and a second physical control channel in accordance with various aspects of this disclosure. The device 1200 may be an implementation of the radio communication device 1402 as shown in FIG. 14. The device 1200 may include a first detector 1202 configured to detect, during a predefined time interval, via a first physical control channel, a plurality of radio resource elements which are contiguous in a predefined frequency range; and a first determining circuit 1204 configured to determine a first signal detection quality based on the detected plurality of resource elements. The device 1200 may further include a second detector 1206 configured to detect, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel; and a second determining circuit 1208 configured to determine a second signal detection quality based on the detected first group of resource elements and the detected second group of resource elements.

The first physical control channel may be a physical downlink control channel; and the second physical control channel may be an enhanced physical downlink control channel. Furthermore, the second physical downlink control channel may control an uplink transmission scheduling of a communication device. The second physical downlink control channel may control a communication device specific uplink transmission scheduling of the communication device. Moreover, the first physical downlink control channel may control a transmission scheduling common for a plurality of communication devices. The second detector 1206 may be configured to determine a signal to noise ratio of the detected resource element of the first group of at least one radio resource element and a signal to noise ratio of the detected resource element of the second group of at least one radio resource element. The second detector 1206 may be configured to determine a signal to interference plus noise ratio of the detected resource element of the first group of at least one radio resource element and a signal to interference plus noise ratio of the detected resource element of the second group of at least one radio resource element. The second detector 1206 may be configured to determine the signal to noise ratio of the detected resource elements based on precoded reference signals. Further, the second detector 1206 may be configured to determine the signal to noise ratio of the detected resource elements based on demodulation reference signals. The second detector 1206 is configured to determine the signal to noise ratio of the detected resource elements taking beam forming into account. The first detector 1202 may be configured to determine a signal to noise ratio of the detected resource elements. Furthermore, the first detector 1202 may be configured to determine a signal to interference plus noise ratio of the detected resource elements. By way of example, the first detector 1202 may be configured to determine the signal to noise ratio of the detected resource elements based on non-precoded reference signals. The first detector 1202 may be configured to determine the signal to noise ratio of the detected resource elements based on radio cell specific reference signals. The predefined time interval may be a predefined time frame or a predefined time subframe.

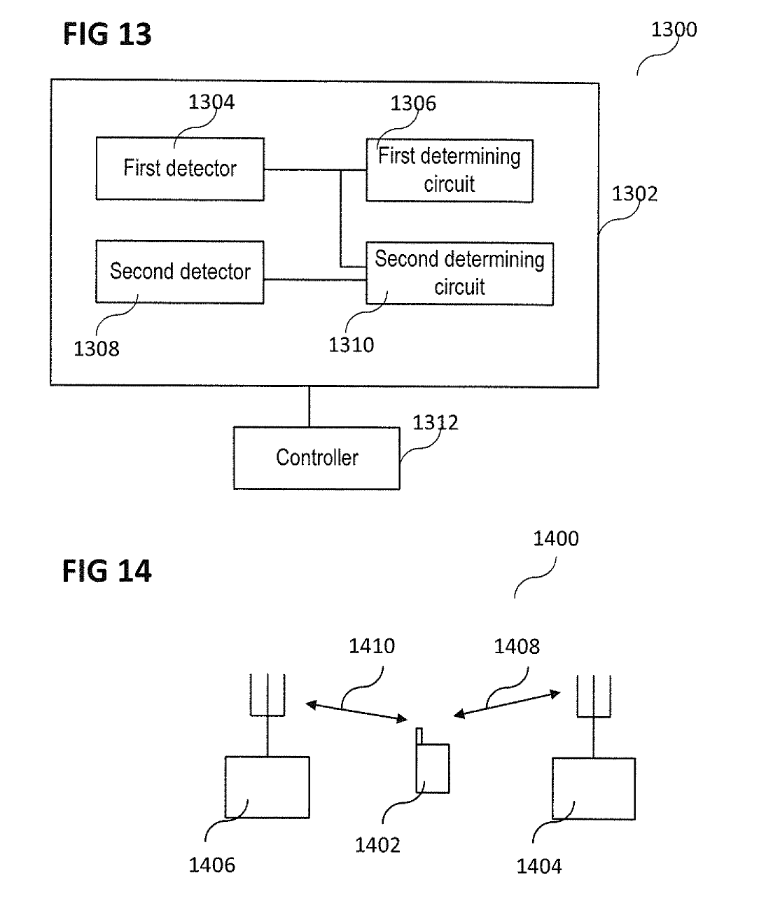

FIG. 13 shows yet another exemplary device 1300 for controlling a communication device in accordance with various aspects of this disclosure. The device 1300 may include: a circuit 1302 configured to determine a signal detection quality for a first physical control channel and a second physical control channel. The circuit 1302 may include: a first detector 1304 configured to detect, during a predefined time interval, via a first physical control channel, a plurality of radio resource elements which are contiguous in a predefined frequency range; a first determining circuit 1306 configured to determine a first signal detection quality based on the detected plurality of resource elements; a second detector 1308 configured to detect, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel; and a second determining circuit 1310 configured to determine a second signal detection quality based on the detected first group of resource elements and the detected second group of resource elements. The device 1300 may further include a controller 1312 (which may be coupled to the circuit 1302) configured to control the communication device dependent on the determined signal detection qualities.

The controller 1312 may further be configured to control the communication device into a synchronization state dependent on the determined signal detection qualities. Further, the synchronization state may be a Radio Resource Control (RRC) synchronization state. The controller 1312 may further be configured to control the communication device to enter into an In-Synchronization state if the determined signal detection quality of the first physical control channel is higher than a first predefined quality threshold, and if the determined signal detection quality of the second physical control channel is higher than a second predefined quality threshold. The controller 1312 may further be configured to control the communication device to enter into an Out-of-Synchronization state if at least one of the determined signal detection quality of the first physical control channel is equal to or smaller than a first predefined quality threshold, and the determined signal detection quality of the second physical control channel is equal to or smaller than a second predefined quality threshold. The controller 1312 may further be configured to control the communication device to enter into an In-Synchronization state if a predefined function taking into account the determined signal detection quality of the first physical control channel and the determined signal detection quality of the second physical control channel fulfills a predefined quality criterion.

The following examples pertain to further embodiments.

Example 1, a method for determining a signal detection quality for a physical control channel, the method may include: detecting, via a physical control channel, a first group of at least one radio resource element and a second group of at least one radio resource element, where the first group and the second group are non-contiguous in time and frequency with respect to radio resource elements of the physical control channel; and determining the signal detection quality based on the detected first group of resource elements and the detected second group of resource elements.

In Example 2, the subject matter of Example 1 may include the physical control channel is a physical downlink control channel.

In Example 3, the subject matter of Example 2 may include the physical downlink control channel is an enhanced physical downlink control channel.

In Example 4, the subject matter of Example 2 may include the physical downlink control channel controls an uplink transmission scheduling of a communication device.

In Example 5, the subject matter of Example 2 may include the physical downlink control channel controls a communication device specific uplink transmission scheduling of the communication device.

In Example 6, the subject matter of Example 1 may include the detecting the first group of at least one radio resource element and the second group of at least one radio resource element comprises determining a signal to noise ratio of the detected resource element of the first group of at least one radio resource element and a signal to noise ratio of the detected resource element of the second group of at least one radio resource element.

In Example 7, the subject matter of Example 6 may include the detecting the first group of at least one radio resource element and the second group of at least one radio resource element comprises determining a signal to interference plus noise ratio of the detected resource element of the first group of at least one radio resource element and a signal to interference plus noise ratio of the detected resource element of the second group of at least one radio resource element.

In Example 8, the subject matter of Example 6 may include the signal to noise ratio of the detected resource elements is determined based on precoded reference signals.

In Example 9, the subject matter of Example 6 may include determining the signal to noise ratio of the detected resource elements taking beam forming into account.

In Example 10, a method for controlling a communication device, the method may include: determining a signal detection quality for a physical control channel, comprising, detecting, via a physical control channel, a first group of at least one radio resource element and a second group of at least one radio resource element, where the first group and the second group are non-contiguous in time and frequency with respect to radio resource elements of the physical control channel; determining the signal detection quality based on the detected first group of resource elements and the detected second group of resource elements; and controlling the communication device dependent on the determined signal detection quality.

In Example 11, the subject matter of Example 10 may include controlling the communication device into a synchronization state dependent on the determined signal detection quality.

In Example 12, the subject matter of Example 11 may include that the synchronization state is a Radio Resource Control (RRC) synchronization state.

In Example 13, the subject matter of Example 11 may include controlling the communication device to enter into an In-Synchronization state if the determined signal detection quality is higher than a predefined quality threshold.

In Example 14, the subject matter of Example 11 may include controlling the communication device to enter into an Out-of-Synchronization state if the determined signal detection quality is equal to or smaller than a predefined quality threshold.

In Example 15, the subject matter of Example 10 may include that the physical control channel is a physical downlink control channel.

In Example 16, the subject matter of Example 15 may include that the physical downlink control channel is an enhanced physical downlink control channel.

In Example 17, the subject matter of Example 15 may include that the physical downlink control channel controls an uplink transmission scheduling of a communication device.

In Example 18, the subject matter of Example 17 may include that the physical downlink control channel controls a communication device specific uplink transmission scheduling of the communication device.

In Example 19, the subject matter of Example 10 may include that the detecting the first group of at least one radio resource element and the second group of at least one radio resource element includes determining a signal to noise ratio of the detected resource element of the first group of at least one radio resource element and a signal to noise ratio of the detected resource element of the second group of at least one radio resource element.

In Example 20, the subject matter of Example 19 may include that the detecting the first group of at least one radio resource element and the second group of at least one radio resource element includes determining a signal to interference plus noise ratio of the detected resource element of the first group of at least one radio resource element and a signal to interference plus noise ratio of the detected resource element of the second group of at least one radio resource element.

In Example 21, the subject matter of Example 19 may include that the signal to noise ratio of the detected resource elements is determined based on precoded reference signals.

In Example 22, the subject matter of Example 21 may include determining the signal to noise ratio of the detected resource elements based on demodulation reference signals.

In Example 23, the subject matter of Example 19 may include determining the signal to noise ratio of the detected resource elements taking beam forming into account.

In Example 24, a method for determining a signal detection quality for a first physical control channel and a second physical control channel may include: detecting, during a predefined time interval, via a first physical control channel, a plurality of radio resource elements which are contiguous in a predefined frequency range; determining a first signal detection quality based on the detected plurality of resource elements; detecting, during the predefined time interval, via a second physical control channel, a first group of at least one radio resource element and a second group of at least one radio resource element, where the first group and the second group are non-contiguous in time and the predefined frequency range with respect to radio resource elements of the physical control channel; and determining a second signal detection quality based on the detected first group of resource elements and the detected second group of resource elements.

In Example 25, the subject matter of Example 24 may include that the first physical control channel is a physical downlink control channel; and that the second physical control channel is an enhanced physical downlink control channel.

In Example 26, the subject matter of Example 25 may include that the second physical downlink control channel controls an uplink transmission scheduling of a communication device.

In Example 27, the subject matter of Example 26 may include that the second physical downlink control channel controls a communication device specific uplink transmission scheduling of the communication device.

In Example 28, the subject matter of Example 24 may include that the first physical downlink control channel controls a transmission scheduling common for a plurality of communication devices.

In Example 29, the subject matter of Example 24 may include that the detecting the first group of at least one radio resource element and the second group of at least one radio resource element includes determining a signal to noise ratio of the detected resource element of the first group of at least one radio resource element and a signal to noise ratio of the detected resource element of the second group of at least one radio resource element.

In Example 30, the subject matter of Example 24 may include that the detecting the first group of at least one radio resource element and the second group of at least one radio resource element includes determining a signal to interference plus noise ratio of the detected resource element of the first group of at least one radio resource element and a signal to interference plus noise ratio of the detected resource element of the second group of at least one radio resource element.

In Example 31, the subject matter of Example 29 may include determining the signal to noise ratio of the detected resource elements based on precoded reference signals.

In Example 32, the subject matter of Example 31 may include determining the signal to noise ratio of the detected resource elements based on demodulation reference signals.

In Example 33, the subject matter of Example 29 may include determining the signal to noise ratio of the detected resource elements taking beam forming into account.

In Example 34, the subject matter of Example 24 may include that detecting the plurality of radio resource elements which are contiguous in the predefined frequency range includes determining a signal to noise ratio of the detected resource elements.

In Example 35, the subject matter of Example 34 may include that detecting the plurality of radio resource elements which are contiguous in the predefined frequency range includes determining a signal to interference plus noise ratio of the detected resource elements.

In Example 36, the subject matter of Example 24 may include determining the signal to noise ratio of the detected resource elements based on non-precoded reference signals.

In Example 37, the subject matter of Example 36 may include determining the signal to noise ratio of the detected resource elements based on radio cell specific reference signals.

In Example 38, the subject matter of Example 24 may include that the predefined time interval is a predefined time frame.

In Example 39, the subject matter of Example 38 may include that the predefined time interval is a predefined time subframe.

In Example 40, a method for controlling a communication device may include: determining a signal detection quality for a first physical control channel and a second physical control channel, comprising: detecting, during a predefined time interval, via a first physical control channel, a plurality of radio resource elements which are contiguous in a predefined frequency range; determining a first signal detection quality based on the detected plurality of resource elements; detecting, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel; determining a second signal detection quality based on the detected first group of resource elements and the detected second group of resource elements; and controlling the communication device dependent on the determined signal detection qualities.

In Example 41, the subject matter of Example 40 may include that the controlling the communication device includes controlling the communication device into a synchronization state dependent on the determined signal detection qualities.

In Example 42, the subject matter of Example 41 may include that the synchronization state is a Radio Resource Control (RRC) synchronization state.

In Example 43, the subject matter of Example 41 may include controlling the communication device to enter into an In-Synchronization state if the determined signal detection quality of the first physical control channel is higher than a first predefined quality threshold, and if the determined signal detection quality of the second physical control channel is higher than a second predefined quality threshold.

In Example 44, the subject matter of Example 41 may include controlling the communication device to enter into an Out-of-Synchronization state if at least one of the determined signal detection quality of the first physical control channel is equal to or smaller than a first predefined quality threshold, and the determined signal detection quality of the second physical control channel is equal to or smaller than a second predefined quality threshold.

In Example 45, the subject matter of Example 41 may include controlling the communication device to enter into an In-Synchronization state if a predefined function taking into account the determined signal detection quality of the first physical control channel and the determined signal detection quality of the second physical control channel fulfills a predefined quality criterion.

In Example 46, a device for determining a signal detection quality for a physical control channel may include: a detector configured to detect, via a physical control channel, a first group of at least one radio resource element and a second group of at least one radio resource element, wherein the first group and the second group are non-contiguous in time and frequency with respect to radio resource elements of the physical control channel; and a determining circuit configured to determine the signal detection quality based on the detected first group of resource elements and the detected second group of resource elements.

In Example 47, the subject matter of Example 46 may include that the physical control channel is a physical downlink control channel.

In Example 48, the subject matter of Example 47 may include that the physical downlink control channel is an enhanced physical downlink control channel.

In Example 49, the subject matter of Example 47 may include that the physical downlink control channel controls an uplink transmission scheduling of a communication device.

In Example 50, the subject matter of Example 49 may include that the physical downlink control channel controls a communication device specific uplink transmission scheduling of the communication device.

In Example 51, the subject matter of Example 46 may include that the detector is further configured to determine a signal to noise ratio of the detected resource element of the first group of at least one radio resource element and a signal to noise ratio of the detected resource element of the second group of at least one radio resource element.

In Example 52, the subject matter of Example 51 may include that the detector is further configured to determine a signal to interference plus noise ratio of the detected resource element of the first group of at least one radio resource element and a signal to interference plus noise ratio of the detected resource element of the second group of at least one radio resource element.

In Example 53, the subject matter of Example 51 may include that the detector is further configured to determine the signal to noise ratio of the detected resource elements based on precoded reference signals.

In Example 54, the subject matter of Example 51 may include that the detector is further configured to determine the signal to noise ratio of the detected resource elements taking beam forming into account.

In Example 55, a device for controlling a communication device may include: a circuit configured to determine a signal detection quality for a physical control channel, comprising: a detector configured to detect, via a physical control channel, a first group of at least one radio resource element and a second group of at least one radio resource element, wherein the first group and the second group are non-contiguous in time and frequency with respect to radio resource elements of the physical control channel; a determining circuit configured to determine the signal detection quality based on the detected first group of resource elements and the detected second group of resource elements; and a controller configured to control the communication device dependent on the determined signal detection quality.

In Example 56, the subject matter of Example 55 may include that the controller is configured to control the communication device into a synchronization state dependent on the determined signal detection quality.

In Example 57, the subject matter of Example 56 may include that the synchronization state is a Radio Resource Control (RRC) synchronization state.

In Example 58, the subject matter of Example 56 may include that the controller is configured to control the communication device to enter into an In-Synchronization state if the determined signal detection quality is higher than a predefined quality threshold.

In Example 59, the subject matter of Example 56 may include that the controller is configured to control the communication device to enter into an Out-of-Synchronization state if the determined signal detection quality is equal to or smaller than a predefined quality threshold.

In Example 60, the subject matter of Example 55 may include that the physical control channel is a physical downlink control channel.

In Example 61, the subject matter of Example 60 may include that the physical downlink control channel is an enhanced physical downlink control channel.

In Example 62, the subject matter of Example 60 may include that the physical downlink control channel controls an uplink transmission scheduling of a communication device.

In Example 63, the subject matter of Example 62 may include that the physical downlink control channel controls a communication device specific uplink transmission scheduling of the communication device.

In Example 64, the subject matter of Example 55 may include that the detector is configured to determine a signal to noise ratio of the detected resource element of the first group of at least one radio resource element and a signal to noise ratio of the detected resource element of the second group of at least one radio resource element.

In Example 65, the subject matter of Example 64 may include that the detector is configured to determine a signal to interference plus noise ratio of the detected resource element of the first group of at least one radio resource element and a signal to interference plus noise ratio of the detected resource element of the second group of at least one radio resource element.

In Example 66, the subject matter of Example 64 may include that the detector is configured to determine the signal to noise ratio of the detected resource elements based on precoded reference signals.

In Example 67, the subject matter of Example 66 may include that the detector is configured to determine the signal to noise ratio of the detected resource elements based on demodulation reference signals.

In Example 68, the subject matter of Example 64 may include that the detector is configured to determine the signal to noise ratio of the detected resource elements taking beam forming into account.

In Example 69, a device for determining a signal detection quality for a first physical control channel and a second physical control channel may include: a first detector configured to detect, during a predefined time interval, via a first physical control channel, a plurality of radio resource elements which are contiguous in a predefined frequency range; a first determining circuit configured to determine a first signal detection quality based on the detected plurality of resource elements; a second detector configured to detect, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel; and a second determining circuit configured to determine a second signal detection quality based on the detected first group of resource elements and the detected second group of resource elements.

In Example 70, the subject matter of Example 69 may include that the first physical control channel is a physical downlink control channel; and wherein the second physical control channel is an enhanced physical downlink control channel.

In Example 71, the subject matter of Example 70 may include that the second physical downlink control channel controls an uplink transmission scheduling of a communication device.

In Example 72, the subject matter of Example 71 may include that the second physical downlink control channel controls a communication device specific uplink transmission scheduling of the communication device.

In Example 73, the subject matter of Example 69 may include that the first physical downlink control channel controls a transmission scheduling common for a plurality of communication devices.

In Example 74, the subject matter of Example 69 may include that the second detector is configured to determine a signal to noise ratio of the detected resource element of the first group of at least one radio resource element and a signal to noise ratio of the detected resource element of the second group of at least one radio resource element.

In Example 75, the subject matter of Example 69 may include that the second detector is configured to determine a signal to interference plus noise ratio of the detected resource element of the first group of at least one radio resource element and a signal to interference plus noise ratio of the detected resource element of the second group of at least one radio resource element.

In Example 76, the subject matter of Example 74 may include that the second detector is configured to determine the signal to noise ratio of the detected resource elements based on precoded reference signals.

In Example 77, the subject matter of Example 76 may include that the second detector is configured to determine the signal to noise ratio of the detected resource elements based on demodulation reference signals.

In Example 78, the subject matter of Example 74 may include that the second detector is configured to determine the signal to noise ratio of the detected resource elements taking beam forming into account.

In Example 79, the subject matter of Example 69 may include that the first detector is configured to determine a signal to noise ratio of the detected resource elements.

In Example 80, the subject matter of Example 79 may include that the first detector is configured to determine a signal to interference plus noise ratio of the detected resource elements.

In Example 81, the subject matter of Example 69 may include that the first detector is configured to determine the signal to noise ratio of the detected resource elements based on non-precoded reference signals.

In Example 82, the subject matter of Example 69 may include that the first detector is configured to determine the signal to noise ratio of the detected resource elements based on radio cell specific reference signals.

In Example 83, the subject matter of Example 69 may include that the predefined time interval is a predefined time frame.

In Example 84, the subject matter of Example 83 may include that the predefined time interval is a predefined time subframe.

In Example 85, a device for controlling a communication device may include: a circuit configured to determine a signal detection quality for a first physical control channel and a second physical control channel, the circuit comprising: a first detector configured to detect, during a predefined time interval, via a first physical control channel, a plurality of radio resource elements which are contiguous in a predefined frequency range; a first determining circuit configured to determine a first signal detection quality based on the detected plurality of resource elements; a second detector configured to detect, during the predefined time interval, via a second physical control channel, a first group of at least one radio resource element and a second group of at least one radio resource element, wherein the first group and the second group are non-contiguous in time and the predefined frequency range with respect to radio resource elements of the physical control channel; and a second determining circuit configured to determine a second signal detection quality based on the detected first group of resource elements and the detected second group of resource elements; a controller configured to control the communication device dependent on the determined signal detection qualities.

In Example 86, the subject matter of Example 85 may include that the controller is further configured to control the communication device into a synchronization state dependent on the determined signal detection qualities.

In Example 87, the subject matter of Example 86 may include that the synchronization state is a Radio Resource Control (RRC) synchronization state.

In Example 88, the subject matter of Example 86 may include that the controller is further configured to control the communication device to enter into an In-Synchronization state if the determined signal detection quality of the first physical control channel is higher than a first predefined quality threshold, and if the determined signal detection quality of the second physical control channel is higher than a second predefined quality threshold.

In Example 89, the subject matter of Example 86 may include that the controller is further configured to control the communication device to enter into an Out-of-Synchronization state if at least one of the determined signal detection quality of the first physical control channel is equal to or smaller than a first predefined quality threshold, and the determined signal detection quality of the second physical control channel is equal to or smaller than a second predefined quality threshold.

In Example 90, the subject matter of Example 86 may include that the controller is further configured to control the communication device to enter into an In-Synchronization state if a predefined function taking into account the determined signal detection quality of the first physical control channel and the determined signal detection quality of the second physical control channel fulfills a predefined quality criterion.

While the disclosure has been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A device for determining a signal detection quality, the device comprising:
a detector configured to detect, via a physical control channel, a first group of at least one radio resource element and a second group of the at least one radio resource element, wherein the first group and the second group are non-contiguous in time and frequency with respect to radio resource elements of the physical control channel; and
a determining circuit configured to determine signal detection quality based on the detected first group of resource elements and the detected second group of resource elements.

2. The device of claim 1,
wherein the physical control channel is a physical downlink control channel.

3. The device of claim 2,
wherein the physical downlink control channel is an enhanced physical downlink control channel.

4. The device of claim 2,
wherein the physical downlink control channel controls an uplink transmission scheduling of a communication device.

5. The device of claim 1,
wherein the detector is further configured to determine a signal to noise ratio of the detected resource element of the first group of at least one radio resource element and a signal to noise ratio of the detected resource element of the second group of at least one radio resource element.

6. The device of claim 5,
wherein the detector is further configured to determine a signal to interference plus noise ratio of the detected resource element of the first group of at least one radio resource element and a signal to interference plus noise ratio of the detected resource element of the second group of at least one radio resource element.

7. The device of claim 5,
wherein the detector is further configured to determine the signal to noise ratio of the detected resource elements based on precoded reference signals.

8. The device of claim 5,
wherein the detector is further configured to determine the signal to noise ratio of the detected resource elements taking beam forming into account.

9. A device for controlling a communication device, the device comprising:
a circuit configured to determine a signal detection quality for a physical control channel, comprising:
a detector configured to detect, via a physical control channel, a first group of at least one radio resource element and a second group of at least one radio resource element, wherein the first group and the second group are non-contiguous in time and frequency with respect to radio resource elements of the physical control channel;
a determining circuit configured to determine the signal detection quality based on the detected first group of resource elements and the detected second group of resource elements;
a controller configured to control the communication device dependent on the determined signal detection quality.

10. The device of claim 9,
wherein the controller is configured to control the communication device into a synchronization state dependent on the determined signal detection quality.

11. The device of claim 10,
wherein the synchronization state is a Radio Resource Control (RRC) synchronization state.

12. The device of claim 10,
wherein the controller is configured to control the communication device to enter into an In-Synchronization state if the determined signal detection quality is higher than a predefined quality threshold.

13. The device of claim 10,
wherein the controller is configured to control the communication device to enter into an Out-of-Synchronization state if the determined signal detection quality is equal to or smaller than a predefined quality threshold.

14. The device of claim 9,
wherein the physical control channel is an enhanced physical downlink control channel.

15. The device of claim 9,
wherein the detector is configured to determine a signal to noise ratio of the detected resource element of the first group of at least one radio resource element and a signal to noise ratio of the detected resource element of the second group of at least one radio resource element.

16. The device of claim 15,
wherein the detector is configured to determine a signal to interference plus noise ratio of the detected resource element of the first group of at least one radio resource element and a signal to interference plus noise ratio of the detected resource element of the second group of at least one radio resource element.

17. The device of claim 15,
wherein the detector is configured to determine the signal to noise ratio of the detected resource elements based on precoded reference signals.

18. The device of claim 17,
wherein the detector is configured to determine the signal to noise ratio of the detected resource elements based on demodulation reference signals.

19. A device for determining a signal detection quality, the device comprising:
a first detector configured to detect, during a predefined time interval, via a first physical control channel, a plurality of radio resource elements which are contiguous in a predefined frequency range;
a first determining circuit configured to determine a first signal detection quality based on the detected plurality of resource elements;
a second detector configured to detect, during the predefined time interval, via a second physical control channel, a first group of at least one radio resource element and a second group of the at least one radio resource element, wherein the first group and the second group are non-contiguous in time and the predefined frequency range with respect to radio resource elements of the physical control channel; and
a second determining circuit configured to determine a second signal detection quality based on the detected first group of resource elements and the detected second group of resource elements.

20. The device of claim 19,
wherein the first physical control channel is a physical downlink control channel; and
wherein the second physical control channel is an enhanced physical downlink control channel.
